(19) United States
(12) Patent Application Publication
(10) Pub. No.: US 2026/0244401 A1
(43) Pub. Date: Aug. 20, 2026

(54) MULTIPLY-ACCUMULATE CIRCUIT, PROCESSOR INCLUDING THE MULTIPLY-ACCUMULATE CIRCUIT, AND COMPUTING DEVICE

(71) Applicant: SHENZHEN MICROBT ELECTRONICS TECHNOLOGY CO., LTD., SHENZHEN, GUANGDONG (CN)

(72) Inventors: Danyang WANG, SHENZHEN, GUANGDONG (CN); Shuangyan CHEN, SHENZHEN, GUANGDONG (CN); Yun ZHAI, SHENZHEN, GUANGDONG (CN); Zhijun FAN, SHENZHEN, GUANGDONG (CN); Zuoxing YANG, SHENZHEN, GUANGDONG (CN)

(73) Assignee: SHENZHEN MICROBT ELECTRONICS TECHNOLOGY CO., LTD., SHENZHEN, GUANGDONG (CN)

(21) Appl. No.: 18/840,199

(22) PCT Filed: Jun. 24, 2024
(86) PCT No.: PCT/CN2024/100906

§ 371 Date: Aug. 21, 2024

(30) Foreign Application Priority Data
Aug. 8, 2023 (CN) 202310990483.3

(51) Int. Cl. G06F 7/544

(52) U.S. Cl. CPC G06F 7/5443

(57) ABSTRACT

Fast vector multiplication and accumulation circuit A fast vector multiplication and accumulation circuit is proposed. The fast vector multiplication and accumulation circuit is applied to an artificial neural network accelerator and used to calculate an inner product of a multiplier vector and a multiplicand vector. The fast vector multiplication and accumulation circuit includes a scheduler, a self-accumulating adder and an adder. The fast vector multiplication and accumulation circuit utilizes a multi-bit compressor of the self-accumulating adder and a binary arithmetic coding of the scheduler to greatly enhance a level of vector parallelism of a long vector inner product operation.

Therefore, the proposed circuit and the method of the present disclosure may utilize the self-accumulating adder combined with application-specific integrated circuits (ASIC) to accomplish a fast inner product operation, thereby greatly reducing the computational complexity, latency and power consumption.

### CROSS-REFERENCE TO RELATED APPLICATIONS

This application is based on and claims priority to Chinese Patent Application No. 202310990483.3 filed on Aug. 8, 2023, the disclosure content of which is incorporated herein in its entirety.

### TECHNICAL FIELD

The present disclosure relates to the field of data processing technologies, and more particularly, to a multiply-accumulate circuit, a processor including the multiply-accumulate circuit, and a computing device.

### BACKGROUND

A multiply-accumulate (MAC) circuit is used to perform operations such as vector multiplication, matrix multiplication, and vector-matrix multiplication, and is a very important operational subsystem in processors such as a coprocessor, a digital signal processor, a central processor, an application-specific instruction processor, and a neural-network processor. Particularly, rapid development of artificial intelligence highlights an important role of the neural-network processor, such that the neural-network processor gradually becomes a cornerstone of intelligent computing technologies. A convolutional computing unit is a core unit of the neural-network processor, implementation of which depends on a multiply-accumulate operation performed by the multiply-accumulate circuit on activation data and weight data. Since the convolutional computing unit is also a center of power consumption of the neural-network a design of a low-power multiply-accumulate circuit is very important for the convolutional computing unit, and is also the key to large-scale application of the neural-network processor including the convolutional computing unit.

### SUMMARY

According to a first aspect of the present disclosure, there is provided a multiply-accumulate circuit, comprising: at least one multiply-accumulate unit, the multiply-accumulate unit comprising: a multiply subcircuit, configured to receive a multiplicator and a multiplicand and multiply the multiplicator and the multiplicand; an accumulate subcircuit, input end of the accumulate subcircuit being coupled to an output end of the multiply subcircuit, and the accumulate subcircuit being configured to receive an output of the multiply subcircuit and accumulate the output; and a control subcircuit, an input end of the control subcircuit being coupled to an output end of the accumulate subcircuit, an output end of the control subcircuit providing an output end of the multiply-accumulate unit, and the control subcircuit being configured to receive a control signal and an output of the accumulate subcircuit and control, according to the control signal, whether to provide the output of the accumulate subcircuit at the output end of the control subcircuit; and a summation unit, an input end of the summation unit being coupled to an output end of the at least one multiply-accumulate unit, and the summation unit being configured to receive an output of the at least one multiply-accumulate unit and sum the output.

In some embodiments, the multiply-accumulate circuit further comprises: the multiply subcircuit comprises one or more multipliers, each of which is configured to receive a corresponding pair of multiplicator and multiplicand and multiply the corresponding pair of multiplicator multiplicand.

In some embodiments, the multiply-accumulate circuit further comprises: the multiplier of the multiply subcircuit has a single output end.

In some embodiments, the multiply-accumulate circuit further comprises: the multiplier of the multiply subcircuit has dual output ends.

In some embodiments, the multiply-accumulate circuit further comprises: the accumulate subcircuit comprises a compression tree and a plurality of register groups, each output end of the compression tree is coupled to an input end of a corresponding register group of the plurality of register groups, and the output end of the multiply subcircuit and an output end of each of the plurality of register groups are respectively corresponding input ends of the compression tree, the output end of each of the plurality of register groups is respectively coupled to a corresponding input end of the control subcircuit, and the control subcircuit is configured to control, according to the control signal, whether to respectively provide an output of each of the plurality of register groups at a correspond ng output end of the control subcircuit.

In some embodiments, the multiply-accumulate circuit further comprises: the control subcircuit comprises: a plurality of control elements, a first input end of each of the plurality of control elements being coupled to an output end of a corresponding register group of the plurality of register groups, a second but end of each of the plurality of control elements being configured to receive a control signal, output end of each of the plurality of control elements being providing a corresponding output end of the multiply-accumulate unit, and each of the plurality of control elements being configured to control, according to the received control signal, whether to provide an output of the corresponding register group at the output end of the control element.

In some embodiments, the multiply-accumulate circuit further comprises: the accumulate subcircuit comprises a full adder module with one or more levels of full adders, a first register group, and a second register group, a first output end of the full adder module is coupled to an input end of the first register group, a second output end of the full adder module is coupled to an input end of the second register group, and the output end of the multiply subcircuit, an output end of the first register group, and an output end of the second register group are respectively coupled to corresponding input ends of the full adder module, the output end of the first register group and the output end of the second register group are respectively coupled to corresponding input ends of the control subcircuit, and the control subcircuit is configured to control, according to the control signal, whether to respectively provide an output of the first register group and an output of the second register group at corresponding output ends of the control subcircuit.

In some embodiments, the multiply-accumulate circuit further comprises: the control subcircuit comprises a first control element, a first input end of the first control element being coupled to the output end of the first register group, a second input end of the first control element being configured to receive a control signal, an output end of the first control element providing a first output end of the multiply-accumulate unit, and the first control element being configured to control, according to the received control signal, whether to provide an output of the first register group at the output end of the first control element; and a second control element, a first input end of the second control element being coupled to the output end of the second register group, a second input end of the second control element being configured to receive a control signal, an output end of the second control element providing a second output end of the multiply-accumulate unit, and the second control element be configured to control, according to the received control signal, whether to provide an output of the second register group at the output end of the second control element.

In some embodiments, the multiply-accumulate circuit further comprises: the control subcircuit comprises at least one of the following: an AND gate, a NAND gate, a multiplexer, and an inverse multiplexer.

In some embodiments, the multiply-accumulate circuit further comprises: the control signal is configured so that the control subcircuit does not provide the output of the accumulate subcircuit at the output end of the control subcircuit before the accumulate subcircuit completes each round of accumulation, and is configured to provide the output of the accumulate subcircuit at the output end of the control subcircuit after the accumulate subcircuit completes the each round of accumulation and before a next round of accumulation starts.

In some embodiments, the multiply-accumulate circuit further comprise: the summation unit comprises an adder

In some embodiments, the multiply-accumulate circuit further comprises: the at least one multiply-accumulate unit comprises two or more multiply-accumulate units, the summation unit comprises n levels of compression trees and an adder, an output end of each of the two or more multiply accumulate units is coupled to a corresponding input end of a first-level compression tree of the n levels of compression trees, an output end of an i^{th}-level compression tree of the n levels of compression trees is coupled to a corresponding input end of an (i+1)^{th}-level compression tree of the n levels of compression trees, and an output end of an n^{th}-level compression tree of the n levels of compression trees is coupled to a corresponding input end of the adder, wherein n is a positive j and i=1, 2, . . . , n−1.

In some embodiments, the multiply-accumulate circuit further comprises: the summation unit further comprises an additional register group, an input end of the additional register group is coupled to an output end of the adder, and an output end of the additional register group is coupled to a corresponding input end of the first-level pression tree of the n levels of compression trees.

According to a second aspect of the present disclosure, these is provided a processor, comprising the multiply-accumulate according to the first aspect of the present disclosure.

According to a third aspect of the present disclosure, there is provided a computing device, comprising the processor according to the second aspect of the present disclosure.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings that constitute a part of the specification depict embodiments of the present disclosure, and we used to explain the principle of the present disclosure together with the specification.

With reference to the accompanying drawings, the present disclosure can be understood more clearly according to the following detailed descriptions, wherein:

FIG. 1 shows a circuit diagram of a multiply-accumulate circuit according to some Comparative examples of the present disclosure;

FIG. 2 shows a schematic block diagram of a multiply-accumulate circuit according to some embodiments of the present disclosure;

FIG. 3 to FIG. 7 respectively show exemplary circuit diagrams for implementing the multiply-accumulate circuit of FIG. 2 according to some embodiments of the present disclosure;

FIG. 8 shows a schematic block diagram of a multiply-accumulate circuit according to some embodiments of the present disclosure;

FIG. 9 to FIG. 11 respectively show exemplary circuit diagrams for implementing the multiply-accumulate circuit of FIG. 8 according to some embodiments of the present disclosure.

It is to be noted that in the embodiments illustrated below, sometimes the same reference signs are jointly used across different accompanying drawings to represent the same parts of parts with the same function, and repeated descriptions thereof are omitted. In the specification, similar numbers and letters are used to represent similar items. Therefore, once a certain item is defined in an accompanying drawing, it does not need to be further discussed in subsequent accompanying drawings.

For ease of understanding, locations, sizes, scopes, and the like of structures shown in the accompanying drawings or the like sometimes do not represent practical locations, sizes, scopes, and the like. Therefore, the disclosed invention is not limited to the locations, the sizes, the scopes, and the like disclosed in accompanying drawings or the like. Moreover, the accompanying drawings are not necessarily drawn to scale, and some features may be enlarged to show details of specific components.

### DETAILED DESCRIPTION

Various exemplary embodiments of the present disclosure are described in detail with reference to the accompanying drawings below. It is to be noted that, unless otherwise illustrated specifically, relative arrangement of components and steps, numerical expressions, and values stated in these embodiments do not limit the scope of the present disclosure.

Practically, the following descriptions of at least one exemplary embodiment are merely illustrative, and in no way constitute limitation on the present disclosure and the application or use thereof. In other words, the structure and the method herein are shown in an exemplary manner to illustrate different embodiments of the structure and the method in the present disclosure. However, a person skilled in the art will understand that they merely illustrate exemplary rather than exhaustive manners in which the present disclosure may be implemented. Moreover, the accompanying drawings a not necessarily drawn to scale, and some features may be enlarged to show details of specific components.

In addition, a technology, a method, and a device known to a person of ordinary skill in the related art may not be discussed in detail, but in proper circumstances, said technology, method, and device shall be regarded as a part of the specification.

In all examples that are shown and discussed herein, any specific value should be interpreted only as an example but not as a limitation. Therefore, there may be different values in other examples of the exemplary embodiments.

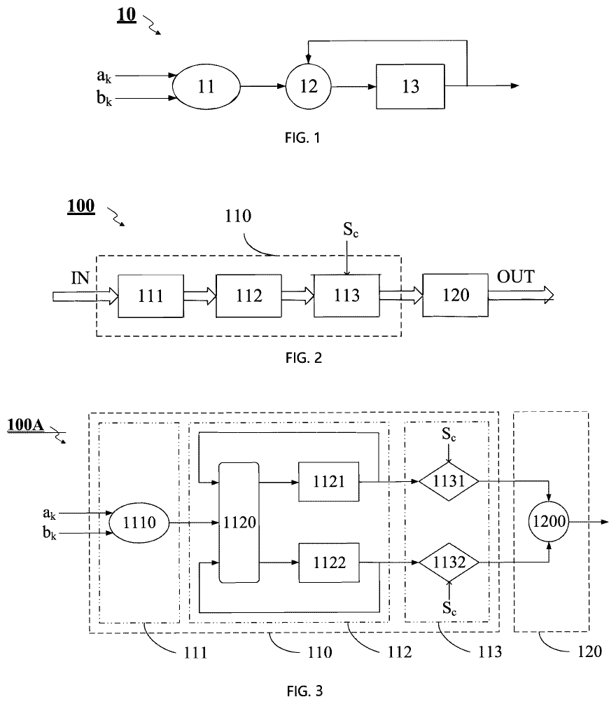

FIG. 1 shows a multiply-accumulate circuit 10, which includes a multiplier 11, an adder 12, and a register 13. It is assumed that the multiply-accumulate circuit 10 is to perform multiply-accumulate calculation on x pairs of numbers (a₁·b₁+a₂b₂+ . . . aₓ·bₓ, x being a positive integer). In this case, in each of x cycles, a corresponding pair of numbers aₖ and bk (k=1, 2, . . . x) among the x pairs of numbers are fed into the multiplier 11 as a multiplicator and a multiplicand to calculate a product aₖ·bₖ of this pair of numbers. Then aₖ·bₖ is accumulated via the adder 12 and the register 13. For example, the x pairs of numbers are sequentially fed from 1 to x. In this case, the result stored in the register 13 at the end of the first cycle is a₁·b₁, the result stored in the register 13 at the end of the second cycle is a₁·b₁+a₂·b₂, . . ., and the result stored in the register 13 at the end of the x^{th} cycle is a₁·b₁+a₂b₂+ . . . aₓ·bₓ. During an entire operation process in which the multiply-accumulate circuit 10 calculates a₁·b₁+a₂b₂+ . . . aₓ·bₓthe multiplier 11 has to perform a multiplication operation in each cycle, the adder 12 has to perform an addition operation in each cycle, and the register 13 has to update a result in each cycle. As a result, the entire multiply-accumulate circuit 10 flips all the time (the flipping indicates that a circuit signal switches from 0 to 1 or from 1 to 0). This leads to the dynamic power consumption of the multiply-accumulate circuit 10 being very high. Particularly, the adder 12 provides an important source of power consumption of the circuit.

In view of this, the present disclosure provides a multiply-accumulate circuit which is divided into a dynamic zone and a static zone. Flipping frequency of a circuit part in the static zone is much lower than that of a circuit part in the dynamic zone. The static zone has low power consumption due to its low flipping frequency, thereby implementing a multiply-accumulate circuit with reduced power consumption. The following describes in detail a multiply-accumulate circuit according to various embodiments of the present disclosure with reference to the accompanying drawings. It is to understood that an actual multiply-accumulate circuit may further Include additional components, and these additional components are not shown in the accompanying drawings or discussed in the present disclosure in order to avoid obfuscating the essence of the present disclosure.

FIG. 2 shows a multiply-accumulate circuit 100 according to some embodiments of the present disclosure. The multiply-accumulate circuit 100 includes a multiply-accumulate unit 110 and a summation unit 120. An input end of the summation unit 120 is coupled to an output end of the multiply-accumulate unit 110. An input end of the multiply-accumulate unit 110 may provide an input end IN of the multiply-accumulate circuit 100, while an output end of the summation unit 120 may provide an output end OUT of the multiply-accumulate circuit 100.

The multiply-accumulate unit 110 includes a multiply subcircuit 111, an accumulate subcircuit 112, and a control subcircuit 113. The multiply subcircuit 111 is configured to receive a multiplicator and a multiplicand and multiply the multiplicator and the multiplicand. An input end of the multiply subcircuit 111 may provide the input end of the multiply-accumulate unit 110. An input end of the accumulate subcircuit 112 is coupled to an output end of the multiply subcircuit 111. The accumulate subcircuit 112 is configured to receive an output of the multiply subcircuit 111 and accumulate the output. An input end of the control subcircuit 113 is coupled to an output end of the accumulate subcircuit 112. An output end of the control subcircuit 113 may provide the output end of the multiply-accumulate unit 110. The control subcircuit 113 is configured to receive a control signal S_{c} and an output of the accumulate subcircuit 112 and control, according to the control signal S_{c} whether to provide the output of the accumulate subcircuit 112 at the output end of the control subcircuit 113. For example, the control signal may be configured such that the control subcircuit 113 does not provide the output of the accumulate subcircuit 112 at the output end of the control subcircuit 113 before the accumulate subcircuit 112 completes each round of accumulation, and is configured to provide the output of the accumulate subcircuit 112 at the output end of the control subcircuit 113 after the accumulate subcircuit 112 completes the each round of accumulation and before a next round of accumulation starts. It is to be noted that, with reference to FIG. 1 for understanding, the “each round of accumulation” herein refers to accumulation performed during a period from a moment at which a register dears a result stored therein each time for preparing for accumulation to a moment at which the register clears a result stored therein the next time for preparing for accumulation, result in the register 13 in FIG. 1 going from 0 to (a₁·b₁+a₂b₂+ . . . aₓ·bₓ) indicating the completion of one round of accumulation, rather than referring to the register updating a result stored therein each time.

The summation unit 120 is configured to receive an output of the multiply-accumulate unit 110 and sum the output. Under the control of the control subcircuit 113, the summation unit 120 does not receive the output of the accumulate subcircuit 112 before the accumulate subcircuit 112 completes the current round of accumulation, and therefore does not perform a summation operation. In other words, under the control of the control subcircuit 113, the output received by the summation unit 120 from the multiply-accumulate unit 110 before the accumulate subcircuit 112 completes the current round of accumulation is always zero. After the accumulate subcircuit 112 completes the current round of accumulation, only then will the summation unit 120, under the control of the control subcircuit 113, receive the output of the accumulate subcircuit 112 and sum the output. In other words, during an entire operation process of the multiply-accumulate unit 110, the multiply-accumulate unit 110 keeps flipping, but the summation unit 120 does not flip. Only after the operation of the multiply-accumulate unit 110 ends, will the summation unit 120 flip one cycle for summation. The multiply-accumulate unit 110 may be considered as a dynamic zone of the multiply-accumulate circuit 100, while the summation unit 120 may be considered as a static zone of the multiply-accumulate circuit 100. The multiply-accumulate circuit 100 achieves reduced power Consumption through the division of the dynamic zone and the static zone.

In some embodiments, the multiply subcircuit 111 may include one or more multipliers, each of which is configured to receive a corresponding pair of multiplicator and multiplicand and multiply the corresponding pair of multiplicator and multiplicand. The multiplier in the multiply subcircuit 111 may be a multiplier with a single output end or a multiplier with dual output ends, which may be configured according to a specific requirement. When the multiply subcircuit 111 includes a plurality of multipliers, parallel computation can be implemented.

In some embodiments, the accumulate subcircuit 112 may include a compression tree and a plurality of register groups, each output end of the compression tree is coupled to an input end of a corresponding one of the plurality of register groups, the output end of the multiply subcircuit 111 and an output end of each of the plurality of register groups are respectively coupled to corresponding input ends of the compression tree, the output end of each of the plurality of register groups is respectively coupled to a corresponding input end of the control subcircuit 113, and the control subcircuit 113 is configured to control, according to the control signal, whether to respectively provide an output of each of the plurality of register groups at a corresponding output end of the control subcircuit 113. Common compression trees include compression trees with two output ends such as a 4:2 compression tree and a 3:2 compression tree, and further include compression trees with three output ends such as a 5:3 compression tree, a 6:3 compression tree, and a 7:3 compression tree. The compression tree used in the accumulate subcircuit 112 may be an existing or later developed compression tree with any number of input ends and output ends, as long as an output result of the multiply subcircuit 111 can be compressed. When the sum of the numb of output e ads of the multiply subcircuit 111 and the number of output ends of the register group greater than the number of input ends of the utilized compression tree, a combination of a plurality of compression trees may alternatively be used (for example, a plurality of levels of compression trees are cascaded, and each level of compression tree may include one compression tree or a plurality of compression trees in parallel). In some embodiments, the control subcircuit 113 may include a plurality of control elements, a first input end of each of the plurality of control elements is coupled to an output end of a corresponding register group of the plurality of register groups, a second input end of each of the plurality of control elements is configure to receive a control signal, an output end of each of the plurality of control elements provides corresponding output end of the multiply-accumulate unit 110, and each plurality of control elements is configured to control, according to the received control signal, whether to provide an output of the corresponding register group at the output end of the control element.

In some other embodiments, the compression tree may alternatively be implemented as a full adder or a combination of a full adder and a half adder For example, in some embodiments, the accumulate subcircuit 112 may include a full adder module with one or more levels of full adders, a first register group, and a second register group, a first output end of the full adder module is coupled to an input end of the first register group, a second output end of the full adder module is coupled to an input end of the second register group, and the output end of the multiply subcircuit 111, an output end of the first register group, and an output end of the second register group are respectively coupled to corresponding input ends of the full adder module. The output end of the first register group and the output end of the second register group are respectively coupled to corresponding input ends of the control subcircuit 113, and the control subcircuit 113 is configured to control, according to the control signal, whether to respectively provide an output of the first register group and an output of the second register group at corresponding output ends of the control subcircuit 113. In some embodiments, the control subcircuit 113 includes a first control element and a second control element. A first input end of the first control element is coupled to the output end of the first register group, a second input end of the first control element is configured to receive a control signal, and an output end of the first control element provides a first output end of the multiply-accumulate unit 110. The first control element is configured to control, according to the received control signal, whether to provide an output of the first register group at the output end of the first control element. A first input end of the second control element is coupled to the output end of the second register group, a second input end of the second control element is configured to receive a control signal, and an output end of the second control element provides a second output end of the multiply-accumulate unit 110. The second control element is configured to control, according to the received control signal, whether to provide an output of the second register group at the output end second control element.

The accumulate subcircuit 112 does not include a adder, so that the accumulate subcircuit 112 does not produce excessively high power consumption even if the accumulate subcircuit 112 keeps flipping during the entire operation process. The number of registers included in a register group may depend on a bit width of the register and a bit width of input data.

In some embodiments, the control subcircuit 113 may include at least one of the following: an AND gate, a NAND gate, a multiplexer, and an inverse multiplexer.

In some embodiments, the summation unit 120 may include an adder. When the multiply-accumulate unit 110 has only two output ends, the summation unit 120 may include only an adder. When the multiply-accumulate unit 110 includes more than two output ends, the summation unit 120 may include n levels of compression trees and an adder, an output end of the multiply-accumulate unit 110 is coupled to a corresponding input end of a first-level compression tree of the n levels of compression trees, an output end of an i^{th}-level compression tree of the n levels of compression trees is coupled to a corresponding input end of an (i+1)^{th}-level compression tree of the n levels of compression trees, and an output end of an n^{th}-level compression tree of the n levels of compression trees is coupled to a corresponding input end of the adder, where n is a positive integer, and i=1, 2, . . . n−1. Each level of compression tree may include one compression tree or a plurality of compression trees in parallel. Similarly, the compression tree herein may alternatively be implemented as a full adder or a combination of a full adder and a half adder. In addition, in some embodiments, the unit 120 may further include an additional register group, an input end of the additional register group is coupled to an output end of the adder, and an output end of the additional register group is coupled to a corresponding input end of the first-level compression tree of the n levels of compression trees. Due to the introduction of he additional register group the summation unit 120 also has an accumulation function. Therefore, the accumulate subcircuit 112 is not necessarily to perform complete accumulation. This lowers the requirement for a bit width of the register groups of the accumulate subcircuit 112, so that registers in the register groups of the accumulate subcircuit 112 can have a smaller number of bits and therefore have a lower area and power consumption.

For non-restrictive illustrative purposes, FIG. 3 to FIG. 7 respectively show exemplary circuit diagrams for implementing the multiply-accumulate circuit 100 of FIG. 2 according to some embodiments of the present disclosure.

As shown in FIG. 3, a multiply-accumulate circuit 100A includes a multiply-accumulate unit 110 and a summation unit 120. The multiply-accumulate unit 110 includes a multiply subcircuit 111, an accumulate subcircuit 112, and a control subcircuit 113. In the example of FIG. 3, the multiply subcircuit 111 includes one multiplier 1110 with a single output end. It is assumed that the multiply-accumulate circuit 100A is to perform multiply-accumulate calculation on x pairs of numbers (a₁·b₁+a₂·b₂+ . . . aₓ·bₓ, x being a positive integer). In this case, in each of x cycles, a corresponding pair of numbers aₖ and bₖ (k=1, 2, . . . x) among the x pairs of numbers may be fed into the multiplier 1110 as a multiplicator and a multiplicand to calculate a product ay by of this pair of numbers. Then aₖ·bₖ is accumulated via the accumulate subcircuit 112.

The accumulate subcircuit 112 includes a compression tree 1120 that is a 3:2 compression tree, and a first register group 1121 as well as a second register group 1122. A first output end of the compression tree 1120 is coupled to an input end of the first register group 1121, and a second output end of the compression tree 1120 is coupled to an input end of the second register group 1122. An output end of the multiplier 1110, an output end of the first register group 1121, and an output end of the second register group 1122 are respectively coupled to corresponding input ends of the compression tree 1120.

The control subcircuit 113 includes a first control element 1131 and a second control element 1132. A first input end of the first control element 1131 is coupled to the output end of the first register group 1121, a second input end of the first control element 1131 is configured to receive a control signal S_{c}, and an output end of the first control element 1131 may provide a first output end of the multiply-accumulate unit 110. The first control element 1131 is configured to control, according to the received control signal S_{c}, whether to provide an output of the first register group 1121 at the output end of the first control element 1131. A first input end of the second control element 1132 is coupled to the output end of the second register group 1122, a second input end of the second control element 1132 is configured to receive a control signal S_{c}, and an output end of the second control element 1132 may provide a second output end of the multiply-accumulate unit 110. The second control element 1132 is configured to control, according to the received control signal S_{c}, whether to provide an output of the second register group 1122 at the output end of the second control element 1132. Each of the first control element 1131 and the second control element 1132 may include at least one of the following: an AND gate, a NAND gate, a multiplexer, and an inverse multiplexer For example, each of the first control element 1131 and the second control element 1132 may include an AND gate group, a NAND gate group, a multiplexer group, or an inverse multiplexer group. The number of elements in the AND gate group, the NAND gate group, the multiplexer group, or the inverse multiplexer group may depend on the bit width of data. For example, when each of the first control element 1131 and the second control element 1132 includes an AND gate group, output of a corresponding register group is not provided at an output end of the control element when the control signal S_{c} is equal to 0 (alternatively, 0 may be output at the output end of the control element), while the output of the corresponding register group is provided at the output end of the control element when the control signal S_{c} is equal to 1. When each of the first control element 1131 and the second control element 1132 includes a multiplexer group, the control signal S_{c} may serve as a selection signal, 0 may serve as first input, and output of a corresponding register group may serve as second input. Therefore, the multiplexer group provides the first input that is 0 at an output end thereof (in other words, does not provide the second input that is the output of the corresponding register group at the output end thereof) when the control signal S_{c} is equal to 0, and provides the second input that is the output of the corresponding register group at the output end thereof when the control signal S_{c} is equal to 1. A case in which each of the first control element 1131 and the second control element 1132 includes a NAND gate group and a case in which each of the first control element 1131 and the second control element 1132 includes a multiplexer group. However, an respectively similar to the case in which each of the first control element 1131 and the second control element 1132 includes an AND gate group and the case in which each of the first control element 1131 and the second control element 1132 includes a multiplexer group. However, an inverse output is provided, which may be corrected within the summation unit 120 by adjusting the configuration of the summation unit 120 (for example, by adding a NOT gate of an inverter).

The summation unit 120 includes one adder 1200. It is assumed that the x pairs of numbers on which the multiply-accumulate circuit 100A is to perform computation are sequentially fed to the multiplier 1110 from 1 to x. In this case, at the end of the first cycle, the result stored in the first register group 1121 is a first part of a₁·b₁, and the result stored in the second register group 1122 is a second part of a₁·b₁; at the end of the second cycle, the result stored in the first register group 1121 is a first part of (a₁·b₁+a₂·b₂)), and the result stored in the second register group 1122 is a second part of (a₁·b₁+a₂·b₂); . . .; at the end of the x^{th} cycle, the result stored in the first register group 1121 is a first part of (a₁·b₁+a₂·b₂+ . . . aₓ·bₓ) and the result stored in the second register group 1122 is a second part of (a₁·b₁+a₂·b₂+ . . . aₓ·bₓ). In the x cycles, under the control of the control signal 5, the adder 1200 does not receive any output from the first register group 1121 or the second register group 1122, and therefore does not flip. In the (x+1)^{th} cycle, the control signal S_{c} is switched to provide, to the adder 1200, the first part of the result (a₁·b₁+a₂·b₂+ . . . aₓ·bₓ)stored in the first register group 1121 and the second part of the result (a₁·b₁+a₂·b₂+ . . . aₓ·bₓ) stored in the second register group 1122, and the adder 1200 performs summation to obtain (a₁·b₁+a₂·b₂+ . . . aₓ·bₓ). Therefore, the adder 1200 flips only one cycle.

Compared with the multiply-accumulate circuit 10 of FIG. 1, in the multiply-accumulate circuit 100A of FIG. 3, after changing one level of accumulate subcircuit into two levels of accumulate subcircuits, the two levels of accumulate subcircuits are respectively disposed in a dynamic zone and a static zone. A first-level accumulate subcircuit in the dynamic zone consists of simple circuit components and does not include an adder. The if flipping frequency is high, it will not cause too much power consumption. A second-level accumulate subcircuit in the static cone includes an adder but has low flipping frequency, and therefore will not cause too much power consumption either. Therefore, the overall multiply-accumulate circuit 100A has reduced power consumption.

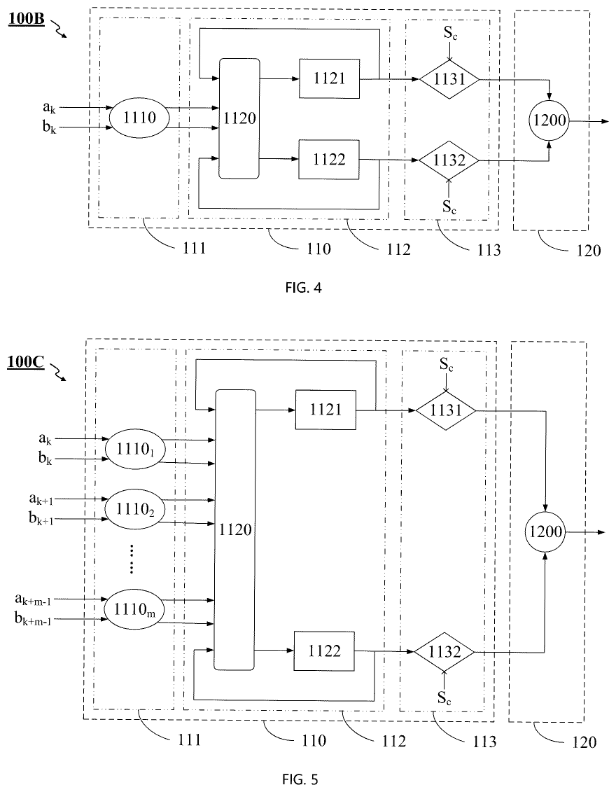

FIG. 4 shows a multiply-accumulate circuit 1008, which differs from the multiply-accumulate circuit 100A of FIG. 3 in that the multiplier 1110 changes from a multiplier with a single output end to a multiplier with dual output ends, and correspondingly, the compression tree 1120 changes from a 3:2 compression tree to a 4:2 compression tree. A multiplier usually includes three parts: a partial product generation part, a partial product accumulation part, and a final addition part. Compared with a multiplier with a single output end, in a multiplier with dual output ends, the final addition part may be reduced, in other words, one adder may be removed. The multiplier 1110 keeps flipping during an entire operation process, and therefore, compared with a case in which a multiplier with a single output end is used, in a case in which a multiplier with dual output ends is used, reduced power consumption can be further achieved.

It can be understood that, although the multiplier with a single output end in the multiply-accumulate circuit 100A of FIG. 3 includes an adder, this adder has a smaller bit width than the adder 1200 or the adder 12 used in the multiply-accumulate circuit 10, and therefore dynamic power consumption is not such high even if the adder in the multiplier with a single output end flips frequently.

FIG. 5 shows a multiply-accumulate circuit 100C, which differs from the multiply-accumulate circuit 100B of FIG. 4 in that the multiply subcircuit 111 includes m parallel multipliers 1110₁, 1110₂, . . . 1110ₘ (m is a positive integer greater than 1), and correspondingly. the compression tree 1120 changes from a 4:2 compression tree to a (2m+2):2 compression tree. As mentioned above, when it is inconvenient to design the (2m+2):2 compression tree, a combination of impression trees may alternatively be used to compress (2m+2) inputs into two outputs. Through the parallel design of the multipliers, the multiply-accumulate circuit 100C can implement multiplication-accumulation on m pairs of numbers in each cycle. Compared with (x+1) cycles that the multiply-accumulate circuit 100B of FIG. 4 requires, the multiply-accumulate circuit 100C requires only (x/m+1) cycles, so that operation efficiency is improved. The number m of parallel multipliers may be flexibly configured according to 3 practical requirement.

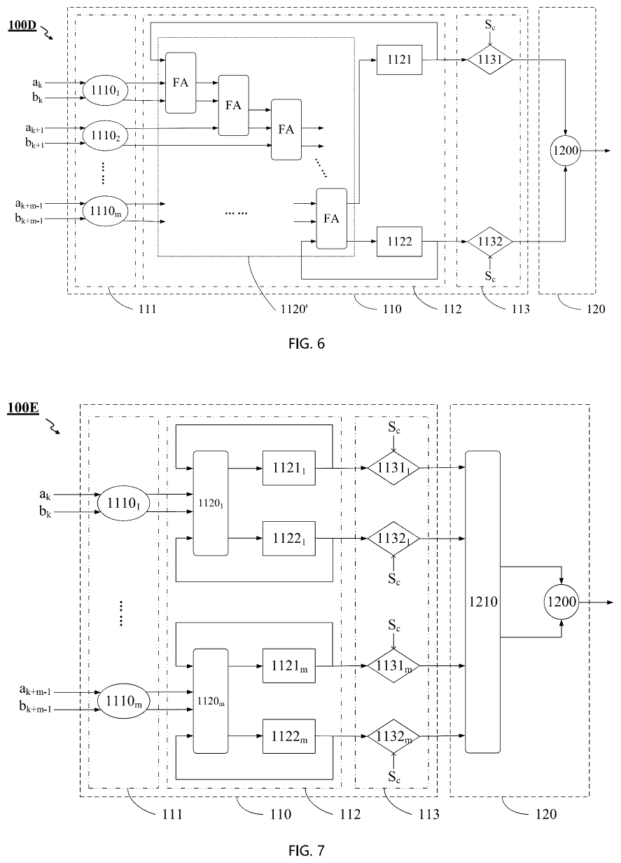

FIG. 6 shows a multiply-accumulate circuit 100D, which differs from the multiply-accumulate circuit 100C of FIG. 5 in that the compression tree 1120 is replaced with a full adder module 1120′ with a plurality of levels of full adders (FA).

FIG. 7 shows a multiply-accumulate circuit 100E, which differs from the multiply-accumulate circuit 100C of FIG. 5 in that the accumulate subcircuit 112 includes m parallel compression trees 1120₁, . . . , 1120ₘ, and output ends of these compression trees are correspondingly provided with first register groups 1121₁, . . . , 1121ₘ, first control elements 1131₁, . . . , 1131ₘ, second register groups 1122₁, . . . , 1122ₘ, and second control elements 1132₁, . . . , 1132ₘ. Although each compression tree is illustrated as corresponding to one multiplier in FIG. 7, it can be understood that a plurality of multipliers may alternatively be disposed in parallel before each compression tree. The compression tree in the multiply-accumulate circuit 100E may have a simpler design compared with the compression tree in the multiply-accumulate circuit 100C. From another perspective, when a same type of compression tree is used in the multiply-accumulate circuit 100E and the multiply-accumulate circuit 100C, the multiply-accumulate circuit 100E can accommodate a larger scale of multipliers, to further improve processing performance of the circuit. Moreover, compared with the accumulate subcircuit 112 of the multiply-accumulate circuit 100C, the accumulate subcircuit 112 of the multiply-accumulate circuit 100E is divided into a plurality of parts for separate accumulation, which avoids the difficulty of timing convergence caused by an excessively large circuit scale in one accumulator part.

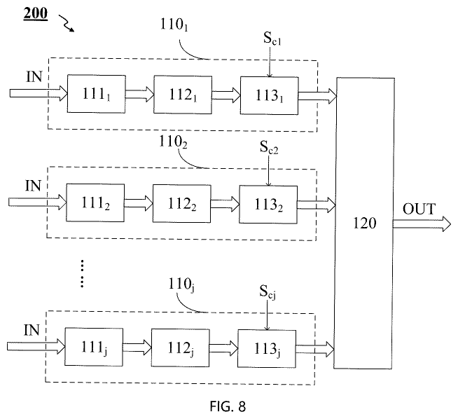

FIG. 8 shows a multiply-accumulate circuit 200 according to some embodiments of the present disclosure. The multiply-accumulate circuit 200 includes a plurality of multiply-accumulate units 110₁, 110₂, . . . , 110ⱼ (j is a positive int er greater than 1) and a summation unit 120. An output end of each of the multiply-accumulate units 110₁, 110₂, . . . , 110ⱼ is coupled to a corresponding input end of the summation unit 120. An input end of each of the multiply-accumulate units 110₁, 110₂, . . . , 110ⱼ may provide an input end IN of the multiply-accumulate circuit 200, while an output end of the summation unit 120 may provide an output end OUT of the multiply-accumulate circuit 200.

The multiply-accumulate units 110₁, 110₂, . . . , 110ⱼ include multiply subcircuits 111₁, 111₂, . . . , 111ⱼ, accumulate subcircuits 112₁, 112₂, . . . , 112ⱼ, and control subcircuits 113₁, 113₂, . . . , 113ⱼ, respectively. The control subcircuits 113₁, 113₂, . . . , 113ⱼ receive control signals S_{c1}, S_{c2}, . . . , S_{cj} respectively. For example, each of the control signals S_{c1}, S_{c2}, . . . , S_{cj} may be configured such that a corresponding control subcircuit of the control subcircuits 113₁, 113₂, . . . , 113ⱼ does not provide an output of a corresponding accumulate subcircuit of the accumulate subcircuits 112₁, 112₂, . . . , 112ⱼ at an output end of the corresponding control subcircuit before the corresponding accumulate subcircuit comprises each round of accumulation, and is configured to provide the output of the corresponding accumulate subcircuit at the output end of the corresponding control subcircuit after the corresponding accumulate subcircuit completes the each round of accumulation and before a next round of accumulation starts.

The summation unit 120 is configured to receive outputs of the plurality of multiply-accumulate units 110₁, 110₂, . . . , 110ⱼ and sum the outputs. Under the control of the control subcircuits 113₁, 113₂, . . . , 113ⱼ, the summation unit 120 does not receive outputs of the accumulate subcircuits 112₁, 112₂, . . . , 112ⱼ before the accumulate subcircuits 112₁, 112₂, . . . , 112ⱼ complete a current round of accumulation, and therefore does not perform a summation operation. After the accumulate subcircuits 112₁, 112₂, . . . , 112ⱼ complete the current round of accumulation, only then will the summation unit 120, under the control of the control subcircuits 113₁, 113₂, . . . , 113ⱼ, receive outputs of the accumulate subcircuits 112₁, 112₂, . . . , 112ⱼ and sums the outputs. In other words, during an entire process of the multiply-accumulate units 110₁, 110₂, . . . , 110ⱼ, the multiply-accumulate units 110₁, 110₂, . . . , 110ⱼ keep flipping, but the summation unit 120 does not flip. Only after the operations of the multiply-accumulate units 110₁, 110₂, . . . , 110ⱼ end, will the summation unit 120 flip one cycle for summation. The multiply-accumulate units 110₁, 110₂, . . . , 110ⱼ may be considered as a dynamic zone of the multiply-accumulate circuit 200, and the summation unit 120 may be considered as a static zone of the multiply-accumulate circuit 200. Power consumption of the multiply-accumulate circuit 200 is reduced through the division of the dynamic zone and the static zone.

Each of the multiply-accumulate units 110₁, 110₂, . . . , 110ⱼ is similar to the multiply-accumulate unit 110 of the multiply-accumulate circuit 100, as described above. Therefore, the foregoing descriptions of the multiply-accumulate unit 110 and various embodiments thereof are also applicable herein. Details are not described herein again. It can be understood that the multiply-accumulate units 110, 1102. 110, may have the same design or different designs.

Compared with the multiply-accumulate circuit 100 with only one multiply-accumulate unit 110, the multiply-accumulate circuit 200 has a plurality of parallel multiply-accumulate units 110₁, 110₂, . . . , 110ⱼ, and each multiply-accumulate unit undertakes a part of accumulation function, so that each multiply-accumulate unit can be kept at an appropriate scale. This avoids the difficulty of timing convergence caused by an excessively large circuit scale of a single multiply-accumulate unit, and facilitates to reduce glitch power consumption and optimize a circuit speed.

Particularly, the plurality of multiply-accumulate units 110₁, 110₂, . . . , 110ⱼ usually have more than two output ends. Thereof, in such embodiments, summation unit 120 may include n levels of compression trees and an adder, an output end of each of the multiply-accumulate units 110₁, 110₂, . . . , 110ⱼ coupled to a corresponding input end of a first-level compression tree of the n levels of compression trees, an output end of an i^{th}-level compression tree of the n levels of compression trees is coupled to a corresponding input end of an (+1)^{th} -level compression tree of the n levels of compression trees, and an output end of an compression tree of the n levels of compression trees is coupled to a corresponding input end of the adder where n is a positive integer, and i=1, 2, . . . , n−1. Each level of compression tree may include one compression tree or a plurality of compression trees. Similarly, the compression tree herein may alternatively be implemented as a full adder or a combination of a full adder and a half adder. In addition, in some embodiments, the summation unit 120 may further include an addition register group, an input end of the register group is coupled to an output end of the adder, and an output end of the additional register group is coupled to a corresponding input end of the first-level compression tree of the n levels of compression trees. Due to the introduction of the additional register group, the summation unit 120 also has an accumulation function. Therefore, an accumulate subcircuit of each of the multiply-accumulate units 110₁, 110₂, . . . , 110ⱼ does not need to perform complete accumulation. This lowers the requirement for a bit width of a register group of the accumulate subcircuit, so that a register in the register group of the accumulate subcircuit can have a smaller number of bits and therefore have a lower area and power consumption.

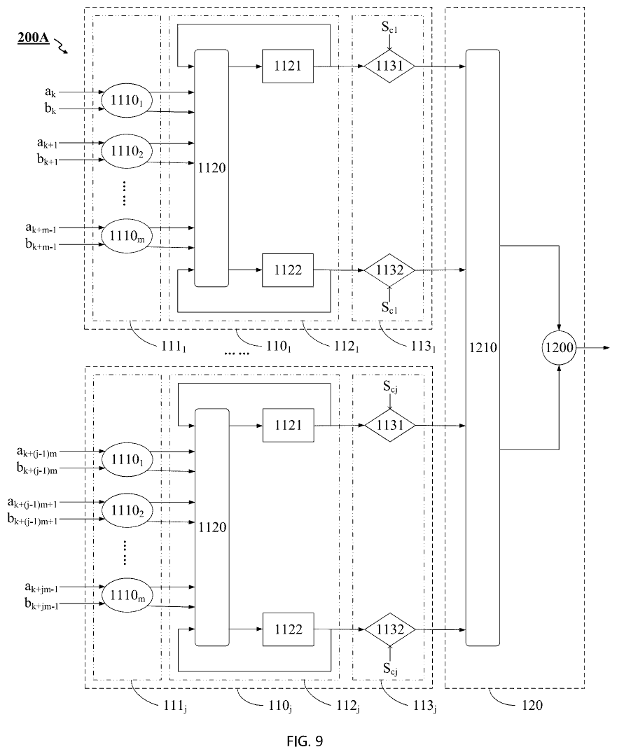

For non-restrictive Illustrative purposes, FIG. 9 to FIG. 11 respectively show exemplary circuit diagrams for implementing the multiply-accumulate circuit 200 of FIG. 8 according to some embodiments of the present disclosure.

FIG. 9 shows a multiply-accumulate circuit 200A, which differs from the multiply-accumulate circuit 100C of FIG. 5 in that the number of multiply-accumulate units changes from 1 to j, and correspondingly, in the summation unit 120, one level of compression tree, namely, a first-level compression tree 1210, is added before the adder 1200 to compress outputs from j multiply-accumulate units 110₁, 110₂, . . . , 110ⱼ. Though the parallel design of the multiply-accumulate units, each multiply-accumulate unit of the multiply-accumulate circuit 200A can implement multiplication-accumulation on m pairs of numbers in each cycle. Compared with (x/m+1) cycles that the multiply-accumulate circuit 100C of FIG. 5 requires, the multiply-accumulate circuit 200A requires only (x/jm+1) cycles, so that operation efficiency is improved. The number j of parallel multiply-accumulate units may be flexibly configured according to a practical requirement.

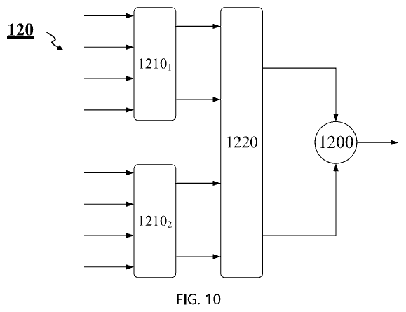

Referring to FIG. 10, it shows that in the summation unit 120, two levels of compression trees are added before the adder 1200, where a first-level compression tree induces two parallel compression trees 1210₁ and 1210₂ a second-level pression tree includes a compression tree 1220, output ends of the multiply-accumulate units 110₁, 110₂, . . . , 110ⱼ are coupled to corresponding input ends of the fir level compression trees 1210₁ and 1210₂, output ends of the first-level compression trees 1210₁ and 1210₂ are coupled to corresponding input ends of the second-level compression tree 1220, output ends of the second-level compression tree 1220 are coupled to the adder 1200, and an output end of the adder 1200 provides an output end of the summation unit 120, and also provides an output end of the multiply-accumulate circuit. FIG. 10 equivalently implements an 8:2 compression tree using a combination of three 4:2 compression trees. The compression tree in the summation unit 120 of FIG. 10 may have a simpler design compared with the compression tree in the summation unit 120 of FIG. 9. From another perspective, when a same type of compression tree is used in the summation unit 120 of FIG. 10 and the summation unit 120 of FIG. 9. the summation unit 120 of FIG. 10 can accommodate a larger scale of multiply-accumulate units, to further improve processing performance of the circuit.

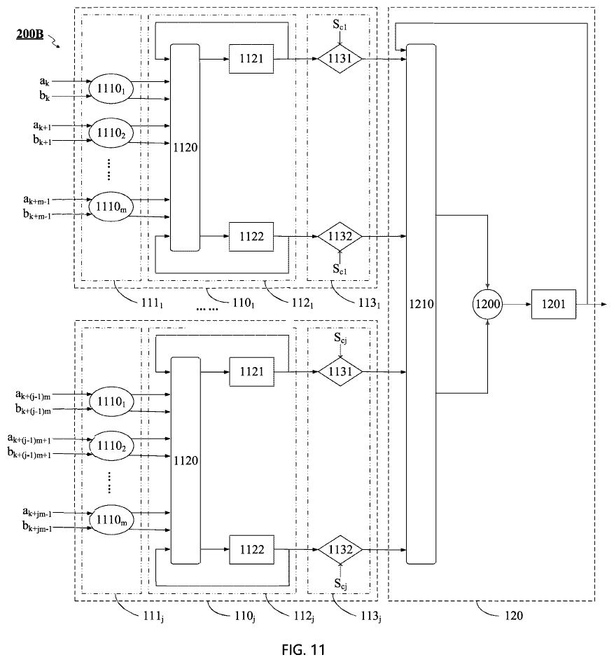

FIG. 11 shows a multiply-accumulate circuit 2008, which differs from the multiply-accumulate circuit 200A of FIG. 9 in that the summation unit 120 further includes an additional register group 1201, an input end of the additional register group 1201 is coupled to an output end of the adder 1200, and an output end of the additional register group 1201 is coupled to a corresponding input end of the first-level compression tree 1210. Due to the Introduction of the additional register group 1201, the summation unit 120 also has an accumulation function. Therefore, an accumulate subcircuit of each of the multiply-accumulate units 110₁, . . . , 110ⱼ does not need to perform complete accumulation. This lowers the requirement for a bit width of a register group of the accumulate subcircuit, so that a register in the register group of the accumulate subcircuit can have a smaller number of bits and therefore have a lower area and power consumption.

For example, it is assumed the multiply-accumulate circuit 2008 is to implement multiplication-accumulation of 1024 pairs of numbers (a, b wed, the multiply-accumulate circuit 2008 includes 4 multiply-accumulate units (j=4), and a multiply subcircuit of each multiply-accumulate unit includes 4 multipliers (m=4). In this case, a typical multiply-accumulate accumulate operation process may be performed as follows. 16 multipliers perform computation in parallel to output 16 multiplication operation results in each cycle. 4 accumulate subcircuits perform accumulation in parallel, and a register group in each accumulate subcircuit is configured to output and clear a stored result every 8 cycles (this means that a round of accumulation includes 8 cycles). Therefore, each accumulate subcircuit provides an output including a multiply-accumulate result of 32 pairs of numbers to the summation unit under the control of a corresponding control subcircuit each time. In other words, the summation unit receives a multiply-accumulate result of 128 pairs of numbers after every 8 cycles. To complete multiplication-accumulation of the 1024 pairs of numbers, the compression tree, the adder, and the additional register group in the summation unit need to flip 8 times.

In comparison multiplication-accumulation of 1024 pairs of numbers is implemented by the multiply-accumulate circuit 10 of FIG. 1, the adder needs to flip 1024 times. It can be learned that, although an accumulation function is introduced in the summation unit 120 of the multiply-accumulate circuit 2008, flipping frequency of the summation unit 120 is still effectively suppressed, so that the multiply-accumulate circuit 2000 has reduced power consumption.

In addition, if multiplication-accumulation of 1024 pairs of numbers is implemented by the multiply-accumulate circuit 200A, the multiply-accumulate circuit 200A also includes 4 multiply-accumulate units (j=4) and a multiply subcircuit of each multiply-accumulate unit also includes 4 multipliers (m=4). In that case, the summation unit 120 needs to flip only once, as described above. Although the flipping frequency of the summation unit 120 of the multiply-accumulate circuit 2008 is higher than the flipping frequency of the summation unit 120 of the multiply-accumulate circuit 200A, power consumption of the multiply-accumulate circuit 2008 and power consumption of the multiply-accumulate circuit 200A are both much lower than power consumption of the multiply-accumulate circuit 10. While in practical applications, reducing power consumption by 1 order of magnitude may already be significant enough. Without considering dynamic power consumption caused by flipping, compared with the multiply-accumulate circuit 200A, the multiply-accumulate circuit 2003 lower a requirement for a bit width of a register group of an accumulate subcircuit, so that a register in the register group of the accumulate subcircuit can have a smaller number of bits and therefore have a lower area and power consumption. Therefore, the multiply-accumulate circuit 2008 further reduces power consumption from another dimension, and improves performance in other aspects.

The present disclosure further provides a processor in another aspect, which may include the multiply-accumulate circuit according to any one of the foregoing embodiments. For example, the processor may be various processors such as a coprocessor, digital signal processor, a central processor an application-specific instruction processor, or a neural-network processor. In the case where such processor is a neural-network processor, a convolutional computing unit of the neural-network processor may include the multiply-accumulate circuit according to any one of the foregoing embodiments.

The present disclosure further provides computing device in still another may include the processor according to any one of the foregoing embodiments. Examples of the computing device may include but are not limited to a consumer electronic product, & Component of a consumer electronic product, an electronic test device, and cellular communications infrastructure such as a base station. Examples of the computing device may include but are not limited to a mobile phone such as a smartphone, a wearable computing device such as a smartwatch or a headset, a telephone, a television, a computer monitor, a computer, a modem, a handheld computer, a laptop computer let computer, a personal digital assistant (PDA), a microwave oven, a refrigerator an in-vehicle electronic system such as an automotive electronic system, a stereo system, a DVD player, a CD player, a digital music player such as an MP3 player, a radio receiver, a camcorder, camera such as a digital camera, a portable memory chip, a washing machine, a dryer, a washing machine/dryer, a peripheral device, and a clock. Moreover, the computing device may include an incomplete product.

The terms “left”, “right”, “front”, “rear”, “top”, “above”, “lower” and the like in the specification and the claims, if present, are used descriptive purpose and are not necessarily used r describing red re e position. It is to be understood that the words used in such a way are interchangeable in proper circumstances so that the embodiments of the present disclosure described herein, for example, can be operated in other orientations that are different from those shown herein or those described otherwise. For example, when the device in the accompanying drawings is turned upside down, a feature originally described as being “above” another feature may be described as being “under” another feature in this case. The device may alternatively be oriented in other manners (rotated 90 degrees or in other orientations). In this case, a relative spatial relationship will be interpreted correspondingly.

In the specification and the claims, when an element is referred to as being “above” another element “attached” to another element, “connected” to another element, “coupled” to another element, “in contact” with another element, or the like, the element may be directly above the another element, directly attached to the another element, directly connected to the another element, directly coupled to the another element, or directly in contact with the another element; or one or more intermediate elements may exist. In contrast, when an element is referred to as being “directly above” another element, “directly attached” to another element, “directly connected”, “directly coupled” to another element, or “in direct contact” with another element, no intermediate element exists. It specification and the claims, a feature being arranged as being “adjacent” to another feature may mean that the feature has a part that overlaps with the adjacent feature or that is located above or under the adjacent feature.

As used herein, the term “exemplary” means “used as an example, instance, or illustration”, and not as a “model” to be accurately copied. Any implementation exemplarily described herein is not necessarily to be construed as preferred or advantageous over other implementations. In addition, the present disclosure is not limited by any stated or implied theory provided in the technical field, background, summary, or detailed description.

As used herein, the term “substantially” means that any minor variation caused by a defect of a design or manufacturing, a tolerance of a device or an element, environmental impact, and/or other factors is included. The term “substantially” also allows for a difference from a perfect or ideal situation caused by parasitic effect, noise, and other practical consideration factors that may exist in practical implementation.

In addition, terms like “first” and “second” may also be used herein for a reference purpose only, and therefore are not intended for a limitation. For example, the terms “first”, “second” and other such numerical terms relating to a structure or an element do not imply a sequence or an order unless the context clearly indicates otherwise.

It is to be further understood that the term “comprise/include”, when used herein, specifies the presence of stated features, integers, steps, operations, units, and/or components, but do not preclude the presence or more other features, integers, steps, operations, units, and/or components, and/or combinations thereof.

In addition, when used in this application, the terms “herein”, “foregoing”, “following”, “hereinafter”, and “hereinabove” and terms of similar meanings shall refer to the entirety of this application but not any specific part of this application. Moreover, unless otherwise stated clearly or interpreted in other manners in the context used, conditional language such as “may”, “can”, “for example”, and “such as” used herein are usually intended to indicate that some embodiments include certain features, elements, and/or states but other embodiments do not. Therefore, such conditional language are usually not intended to imply that features, elements, and/or states are required in any manner in one or more embodiments, or imply whether these features, elements, and/or states an included, or imply that these features, elements, and/or states are implemented in any specific embodiment.

In the present disclosure, the term “provide” is used broadly for covering all manners of obtaining an object. Therefore “providing an object” includes but is not limited to “purchasing”, “preparing/manufacturing”, “arranging/setting”, “installing/assembling”, and/or “ordering” the object, etc.

As used herein, the term “and/or” includes any and all combination one or more of associated listed items. The terms used herein are merely for the purpose of describing specific embodiments but not intended to limit the present disclosure. The singular forms “a”, “an”, and “the” as used herein are intended to include plural forms as well, unless otherwise clearly stated in the context.

A person skilled in the art should appreciate that the boundaries between the operations as described above are merely illustrative. A plurality of operations may be combined into a single operation, a single operation may be distributed in an additional operation, and operations may be performed at least partially overlapping in time. In addition, alternative embodiments may include a plurality of instances of a specific operation, and an operation order may be changed in various other embodiments. Other modifications, changes, and replacements, however, also possible. Aspects and elements of all embodiments disclosed above may be combined in any manner and/or combined with a or elements of other embodiments to provide a plurality of additional embodiments. Therefore, the specification and the accompanying drawings are to be regarded as illustrative rather than restrictive. In practice, the novel device method, and system described herein may be embodied in various other forms. Moreover, various omissions, replacements, and changes may be made to the forms of the method and the system described herein without departing from the spirit of the present disclosure. For example, although blocks are shown in a given arrangement alternative embodiments, similar functions with different components and/or circuit topologies may be performed, and some blocks may be removed, moved, added, subdivided, combined, and/or modified. Each of these blocks may be implemented in various different manners.

Each embodiment of the present disclosure may be described in a progressive manner. For same or similar parts between each embodiment, can refer to each other. Descriptions of each embodiment focus on a difference from other embodiments. In the present disclosure, descriptions with reference to the term “an embodiment”, “some embodiments”, “an example”, “a specific example”, “some examples”, or the like mean that specific features, structures, materials, or characteristics described in conjunction with the embodiment or example are included in at least one embodiment or example of the present disclosure. In the present disclosure, exemplary descriptions of the foregoing terms do not necessarily refer to a same embodiment or example. In addition, the described specific features, structures, materials, or characteristics may be combined in proper manners in any one or more embodiments or examples.

Although some specific embodiments of the present disclosure are described in detail by examples skilled in the art is to understand that the foregoing examples are merely used for description, but not for limiting the scope of the present disclosure. Each embodiment disclosed herein may be combined in any combination without departing from the spirit and scope of the present disclosure. A person skilled in the art is to further understand that various modifications may be made to the embodiments without parting from the scope and spirit of the present disclosure. The scope of the present disclosure is defined by the appended claims.

1. A multiply-accumulate circuit, comprising:
at least one multiply-accumulate unit, the multiply-accumulate unit comprising:
a multiply subcircuit, configured to receive a multiplicator and a multiplicand and multiply the multiplicator and the multiplicand;
an accumulate subcircuit, an input end of the accumulate subcircuit being coupled to an output end of the multiply subcircuit, and the accumulate subcircuit being configured to receive an output of the multiply subcircuit and accumulate the output; and
a control subcircuit, an input end of the control subcircuit being coupled to an output end of the accumulate subcircuit, an output end of the control subcircuit providing an output end of the multiply-accumulate unit, and the control subcircuit being configured to receive a control signal and an output of the accumulate subcircuit and control, according to the control signal, whether to provide the output of the accumulate subcircuit at the output end of the control subcircuit; and
a summation unit, an input end of the summation unit being coupled to an output end of the at least one multiply-accumulate unit, and the summation unit being configured to receive an output of the at least one multiply-accumulate unit and sum the output.

2. The multiply-accumulate circuit according to claim 1, wherein the multiply subcircuit comprises one or more multipliers, each of which is configured to receive a corresponding pair of multiplicator and multiplicand and multiply the corresponding pair of multiplicator and multiplicand.

3. The multiply-accumulate circuit according to claim 2, wherein the multiplier of the multiply subcircuit has a single output end.

4. The multiply-accumulate circuit according to claim 2, wherein the multiplier of the multiply subcircuit has dual output ends.

5. The multiply-accumulate circuit according to claim 1, wherein the accumulate subcircuit comprises a compression tree and a plurality of register groups, each output end of the compression tree is coupled to an input end of a corresponding register group of the plurality of register groups, and the output end of the multiply subcircuit and an output end of each of the plurality of register groups are respectively coupled to corresponding input ends of the compression tree,
wherein the output end of each of the plurality of register groups is respectively coupled to a corresponding input end of the control subcircuit, and the control subcircuit is configured to control, according to the control signal, whether to respectively provide an output of each of the plurality of register groups at a corresponding output end of the control subcircuit.

6. The multiply-accumulate circuit according to claim 5, wherein the control subcircuit comprises:
a plurality of control elements, a first input end of each of the plurality of control elements being coupled to an output end of a corresponding register group of the plurality of register groups, a second input end of each of the plurality of control elements being configured to receive a control signal, an output end of each of the plurality of control elements providing a corresponding output end of the multiply-accumulate unit, and each of the plurality of control elements being configured to control, according to the received control signal, whether to provide an output of the corresponding register group at the output end of the control element.

7. The multiply-accumulate circuit according to claim 1, wherein the accumulate subcircuit comprises a full adder module with one or more levels of full adders, a first register group, and a second register group, a first output end of the full adder module is coupled to an input end of the first register group, a second output end of the full adder module is coupled to an input end of the second register group, and the output end of the multiply subcircuit, an output end of the first register group, and an output end of the second register group are respectively coupled to corresponding input ends of the full adder module,
wherein the output end of the first register group and the output end of the second register group are respectively coupled to corresponding input ends of the control subcircuit, and the control subcircuit is configured to control, according to the control signal, whether to respectively provide an output of the first register group and an output of the second register group at corresponding output ends of the control subcircuit.

8. The multiply-accumulate circuit according to claim 7, wherein the control subcircuit comprises:
a first control element, a first input end of the first control element being coupled to the output end of the first register group, a second input end of the first control element being configured to receive a control signal, an output end of the first control element providing a first output end of the multiply-accumulate unit, and the first control element being configured to control, according to the received control signal, whether to provide an output of the first register group at the output end of the first control element; and
a second control element, a first input end of the second control element being coupled to the output end of the second register group, a second input end of the second control element being configured to receive a control signal, an output end of the second control element providing a second output end of the multiply-accumulate unit, and the second control element being configured to control, according to the received control signal, whether to provide an output of the second register group at the output end of the second control element.

9. The multiply-accumulate circuit according to claim 1, wherein the control subcircuit comprises at least one of the following: an AND gate, a NAND gate, a multiplexer, and an inverse multiplexer.

10. The multiply-accumulate circuit according to claim 1, wherein the control signal is configured so that the control subcircuit does not provide the output of the accumulate subcircuit at the output end of the control subcircuit before the accumulate subcircuit completes each round of accumulation, and is configured to provide the output of the accumulate subcircuit at the output end of the control subcircuit after the accumulate subcircuit completes the each round of accumulation and before a next round of accumulation starts.

11. The multiply-accumulate circuit according claim 1, wherein the summation unit comprises an adder.

12. The multiply-accumulate circuit according claim 1, wherein the at least one multiply-accumulate unit comprises two or more multiply-accumulate units, the summation unit comprises n levels of compression trees and an adder, an output end of each of the two or more multiply-accumulate units is coupled to a corresponding input end of a first-level compression tree of the n levels of compression trees, an output end of an ith-level compression tree of the n levels of compression trees is coupled to a corresponding input end of an (i+1)th-level compression tree of the n levels of compression trees, and an output end of an nth-level compression tree of the n levels of compression trees is coupled to a corresponding input end of the adder,
wherein n is a positive integer, and i=1, 2, ..., n−1.

13. The multiply-accumulate circuit according to claim 12, wherein the summation unit further comprises an additional register group, an input end of the additional register group is coupled to an output end of the adder, and an output end of the additional register group is coupled to a corresponding input end of the first-level compression tree of the n levels of compression trees.

14. A processor, comprising the multiply-accumulate circuit according to claim 1.

15. A computing device, comprising the processor according to claim 14.
